(19) United States
(12) Patent Application Publication
(10) Pub. No.: US 2013/0018819 A1
(43) Pub. Date: Jan. 17, 2013

(54) SYSTEMS AND METHODS FOR OPTIMIZING AN INVESTMENT PORTFOLIO

(71) Applicant: NICO WILLIS, Phoenix, AZ (US)

(72) Inventor: NICO WILLIS, Phoenix, AZ (US)

(73) Assignee: NetWorth Services, Inc.

(21) Appl. No.: 13/550,458

(22) Filed: Jul. 16, 2012

Related U.S. Application Data
(60) Provisional application No. 61/508,009, filed on Jul. 14, 2011.

(51) Int. Cl. G06Q 40/00

(52) U.S. Cl. 705/36 R

(57) ABSTRACT

Systems and methods for determining an optimal allocation of assets in an investment portfolio according to various aspects of the present invention may comprise a graphical user interface, database, asset allocation engine, and a display. The graphical user interface may be configured to receive identifying information about the assets and a financial risk tolerance profile of the asset owner. The database may be configured to store and/or retrieve information associated with the assets. The asset allocation engine may be configured to identify a deficiency between an existing allocation of assets in the portfolio and a target asset allocation model. The display may be configured to present the target asset allocation model and identified deficiencies.

### CROSS-REFERENCE TO RELATED APPLICATIONS

The present application claims the benefit of and priority to Provisional Patent Application Ser. No. 61/508,009, entitled SYSTEMS AND METHODS FOR OPTIMIZING AN INVESTMENT PORTFOLIO, filed on Jul. 14, 2011 and incorporates the disclosure of the application by reference.

### BACKGROUND OF THE INVENTION

An investment portfolio has an asset allocation that may be described as the percentage of assets in each asset class, such as equities, cash equivalents, and fixed-income assets. Diversifying assets among a broad range of asset classes is generally considered to be an important part of constructing a balanced investment portfolio to achieve the financial goals of the investor, manage changes in economic trends, and comport with the investor's tolerance for risk.

The assets in each asset class in an investment portfolio may belong to a wide variety of industry segments with each segment comprising companies with similar business activities, such as energy, electronics, and/or retail. The assets in each asset class may also belong to a sector comprising general segments of an economy, such as basic materials, financial services, and/or technology. These sectors can be further divided into the industry segments.

Optimizing a portfolio by balancing the assets in the portfolio among asset classes, industry segments, and/or sectors may be a complicated and time consuming process requiring research, calculation, and time to present asset allocation models to the asset owner. Specifically, balancing the assets may require consideration of market conditions, historical data about the asset, and consideration of the preferences of the assets' owner.

### SUMMARY OF INVENTION

Systems and methods for determining an optimal allocation of assets in an investment portfolio according to various aspects of the present invention may comprise a graphical user interface, database, asset allocation engine, and a display. The graphical user interface may be configured to receive identifying information about the assets and a financial risk tolerance profile of the asset owner. The database may be configured to store and/or retrieve information associated with the assets. The asset allocation engine may be configured to identify a deficiency between an existing allocation of assets in the portfolio and a target asset allocation model. The display may be configured to present the target asset allocation model and the identified deficiencies.

### BRIEF DESCRIPTION OF THE DRAWING FIGURES

A more complete understanding of the present invention may be derived by referring to the detailed description when considered in connection with the following illustrative figures. In the following figures, like reference numbers refer to similar elements and steps throughout the figures.

FIG. 1 is a block diagram representatively illustrating a financial advisory system in accordance with an exemplary embodiment of the present invention;

FIGS. 2A and 2B depict a screen shot of a graphical user interface that may be accessed by a user to identify the user and for the user to enter a listing of financial accounts in accordance with an embodiment of the present invention;

FIGS. 3A-3C depict screen shots of a graphical user interface that may be accessed by a user to enter information relating to the risk tolerance of the asset owner in accordance with an embodiment of the present invention;

FIG. 4A-4E depict screen shots of a graphical user interface that may be accessed by a user to edit asset data in accordance with an embodiment of the present invention;

FIGS. 5A-5F depict screen shots of a graphical user interface that may be accessed by a user to view uploaded asset data in accordance with an embodiment of the present invention;

FIG. 6 depicts a screen shot of a graphical user interface that may be accessed by a user to view alerts relating to the assets in accordance with an embodiment of the present invention;

FIGS. 7A and 7B depict screen shots illustrating an existing asset allocation scheme and a target asset allocation model in accordance with an embodiment of the present invention;

FIGS. 8A-8I depict screen shots illustrating reports that may be generated by the financial advisory system in accordance with an additional embodiment of the present invention; and

FIG. 9 is a flow chart illustrating a method of operation of a representative implementation of the financial advisory system by a user.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DETAILED DESCRIPTION OF EXEMPLARY EMBODIMENTS

The present invention may be described in terms of functional block components and various processing steps. Such functional blocks may be realized by any number of components configured to perform the specified functions and achieve the various results. For example, the present invention may employ various process steps, apparatus, systems, methods, etc. In addition, the present invention may be practiced in conjunction with any number of systems and methods for providing a computer-implemented system or method for determining the optimal allocation of a plurality of assets associated with an asset owner's investment portfolio. Further, the present invention may employ any number of conventional techniques for acquiring identifying information for an asset, identifying tax lots, determining the dates of purchase of an asset, evaluating the financial goals and/or risk tolerance of an asset owner, calculating the allocation of assets into asset classes, industry segments, and/or sectors, determining a target allocation of assets for the asset owner, analyzing market trends, evaluating the quality of an asset, determining the compound annual growth rate of an asset, determining the price and/or fair market value of the security, commodity, and/or property at any given time, populating tax reports, evaluating gains and/or losses in value of asset, and the like.

The particular implementations shown and described are illustrative of the invention and its best mode and are not intended to limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

Various representative implementations of the present invention may be applied to any system or method for determining the optimal allocation of a plurality of assets associated with an asset owner's investment portfolio. Certain representative implementations may comprise a user interface, such as a website interface or graphical user interface, and/or a database for storing, updating, exchanging, analyzing, processing, communicating, and/or displaying the acquired information relating to the reallocation of assets.

Software and/or software elements according to various aspects of the present invention may be implemented with any appropriate programming or scripting language, such as, C, C++, Java, COBOL, assembler, PERL, eXtensible Markup Language (XML), HTML, PHP, etc., or any other suitable programming and/or scripting language.

Various representative algorithms may be implemented with any suitable combination of data structures, objects, processes, routines and/or other programming elements. Further, the present invention may employ any number of conventional techniques for data transmission, signaling, data processing, network control, and/or the like. Applications according to various aspects of the present invention may be formulated and a network may be provided that may include any system for exchanging data, such as the Internet, an intranet, an extranet, WAN, LAN, satellite communications, any suitable wireless Internet connection, and/or the like. The network may be implemented as other types of networks, such as an interactive television (ITV) network. The users may interact with the system by any input device such as a keyboard, mouse, kiosk, personal digital assistant, handheld computer, cellular phone such as a Smartphone that may have access to the Internet, text messaging by cellular phone, and/or the like. Similarly, the invention may be used in conjunction with any type of personal computer, network computer, workstation, minicomputer, mainframe, or the like running any operating system such as any version of Windows, Windows XP, Windows Longhorn, Windows Whistler, Windows ME, Windows Mobile, Windows NT, Windows 2000, Windows Server, Windows 98, Windows 95, Windows Vista, Windows 7, MacOS, OS/2, BeOS, Linux, UNIX, or any other operating system, whether now known or known hereafter in the art. Moreover, the invention may be implemented with TCP/IP communications, IPX, AppleTalk, IP-6, NetBIOS, OSI or any number of existing or future protocols. Moreover, the system may comprise the use, sale and/or distribution of all goods, services, and/or information having similar functionality described herein.

The system may be connected by a data communication network. The data communication network may be a public network, and may be secure or unsecure and open to eavesdroppers. In one exemplary implementation, the data communication network may be embodied as the Internet. In this context, computers may or may not be connected to the Internet at all times.

A variety of conventional communications media and protocols may be used for data links, such as a connection to an Internet Service Provider (ISP) over a local loop as is typically used in connection with standard modern communication, wireless cellular communication, cable modem, satellite television providers, Integrated Service Digital Network (ISDN), Digital Subscriber Line (DSL), and/or various wireless communication methods. Polymorph code systems might also reside within a local area network (LAN) which interfaces to a network through a leased line (T1, T3, etc.).

The present invention may be embodied as a method, a system, a device, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code embodied in the storage medium. Any suitable non-transitory computer-readable storage medium may be utilized, including hard disks, CD-ROM, optical storage devices, magnetic storage devices, and/or USB memory keys and the like.

Data communication may be accomplished through any suitable communication system, such as, a telephone network, intranet, Internet, point of interaction device (point of sale device, personal digital assistant, cellular phone, kiosk, etc.), online communications, off-line communications, wireless communications, a radio dispatch network, and/or the like. Further, for security reasons, any databases, systems, and/or components of the present invention may comprise any combination of databases or components at a single location or at multiple locations, wherein each database or system includes any of various suitable security features, such as firewalls, access codes, encryption, de-encryption, compression, decompression, and/or the like.

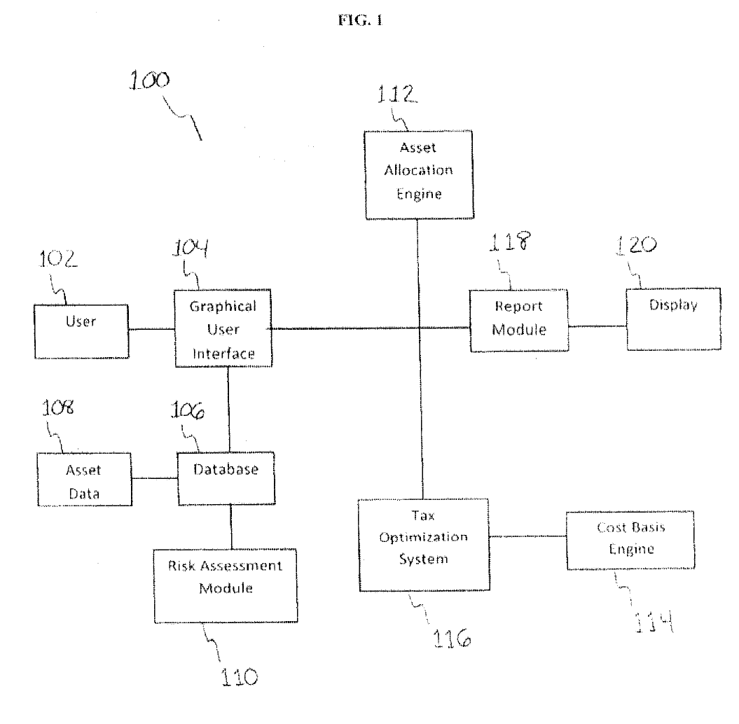

Referring now to FIG. 1, systems and methods for determining the optimal allocation of a plurality of assets associated with an asset owner's investment portfolio according to various aspects of the present invention may be representatively illustrated by a financial advisory system 100 for access by a user 102. The financial advisory system 100 may comprise a graphical user interface 104, such as a website interface, for access by the user 102.

The user 102 may comprise an individual, such as the owner of the plurality of assets (hereinafter the asset owner) that may be subject to evaluation for optimal allocation into at least one of an asset class, an industry segment, and/or a sector. The user 102 may also comprise any suitable person, company, institution and the like that may buy, sell, trade, value, and/or provide financial advice regarding the plurality of assets associated with the asset owner's investment portfolio. For example, the user 102 may comprise an investment broker and/or dealer, a mutual fund company, a tax professional, a government department such as the IRS, and/or a. non-profit institution such as a university or charity and the like.

In one embodiment, according to various aspects of the present invention, the user 102 may own, transact business, evaluate and/or otherwise interact with the assets such as securities, commodities, property such as jewelry, art, and/or real estate, intellectual property, goodwill, and equity ownership interests. The user 102 may access the graphical user interface 104, such as through a personal computer or an online website, to determine the optimal allocation for the plurality of assets in the asset owner's investment portfolio.

The graphical user interface 104 may comprise any suitable system for communicating, accessing, updating, exchanging information, organizing information, and/or managing information such as by data collection, encryption, acquisition, storage, dissemination, and the like. In one embodiment, the graphical user interface 104 may comprise a website interface, such as an interface for a web server. For example, the web server may comprise a Microsoft® Windows® Internet Information Services (IIS) Web Server.

In one embodiment, the financial advisory system 100 may comprise a database 106 that may store information entered by the user 102, such as to save the information for the user 102 to access at a later date. The database 106 may also comprise other stored information, such as information further discussed below.

In one embodiment, according to various aspects of the present invention, the database 106 may be accessible by the user 102 via the graphical user interface 104 and may store asset data 108 entered by the user 102. The asset data 108 may comprise any information associated with the plurality of assets in the asset owner's investment portfolio. For example, the asset data 108 may comprise information identifying the asset, such as a security which may be a bond, stock, mutual fund, option, and/or commodity. The asset may also comprise real estate, cash and cash equivalents, such as treasury bills, certificates of deposit (CD), and/or money market funds.

The information may comprise a company name, company symbol, and/or a CUSIP number identifying the asset, and may be entered into the graphical user interface 104 by the user 102. In one embodiment, the database 106 may store a directory of company names, symbols, and/or CUSIP numbers for the user 102 to select.

In an exemplary embodiment of the present invention, the database 106 may be accessible to the user 102 via the graphical user interface 104 and may store tax laws and/or regulations, such as the rate of taxation of the asset for use by a tax optimization system 116. The tax optimization system 116 may optimize the selection of tax lots of the plurality of assets entered into the database 106 by the user 102 to achieve a desired goal by the asset owner and/or the user 102, such as to minimize the tax resulting from the sale of one or more of the plurality of assets. An exemplary tax optimization system 116 is disclosed in U.S. Patent Publication No. 2011/0161247, published Jun. 30, 2011, the contents of which are herein incorporated by reference.

In one embodiment, the tax optimization system 116 may comprise a cost basis engine 114. The cost basis engine 114 may utilize the asset data 108 to create tax lots that may be displayed to the user 102. An exemplary cost basis engine 114 is disclosed in U.S. Pat. No. 7,606,753 and U.S. Patent Publication No. 2010/0017343, the contents of which are herein incorporated by reference.

In one embodiment, according to various aspects of the present invention, the database 106 may access any suitable repository database containing information about the asset. The repository database may be any electronic repository that may be accessible, such as through the Internet. For example, the graphical user interface 104 may access a security database table (not shown) that may store historical price information for the security, such as a stock, bond, mutual fund and/or the like. In one embodiment, the security database table may store a high price, low price, and/or an open price for the security on any day. The security database table may also comprise data for securities having a single price per day, such as mutual funds having a Net Asset Value at close of trading.

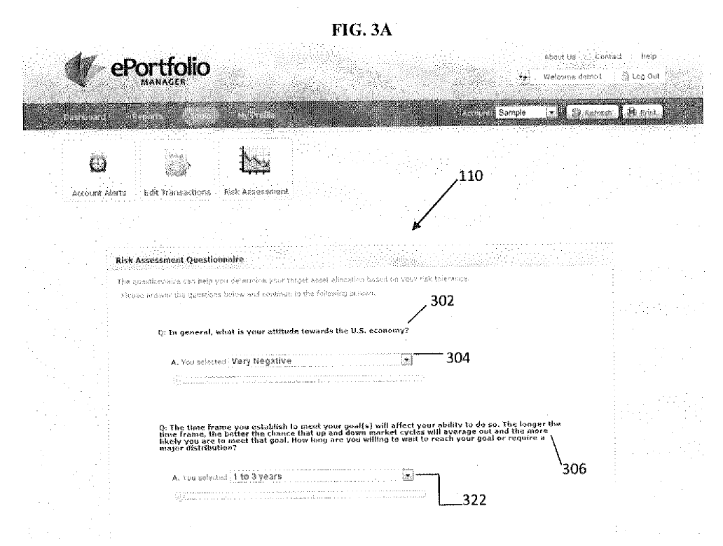

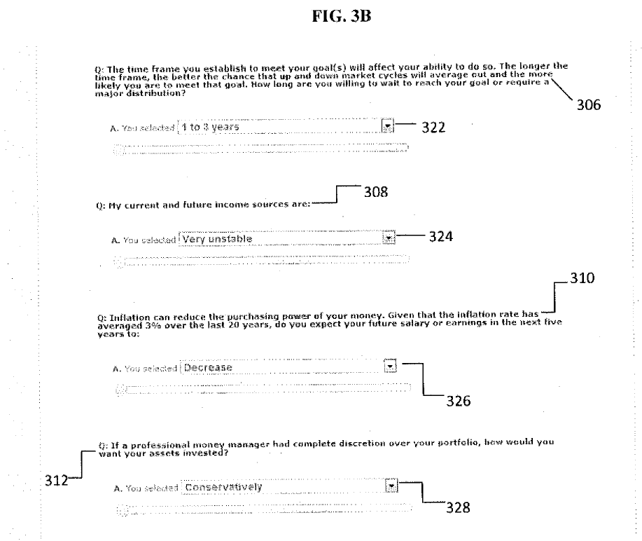

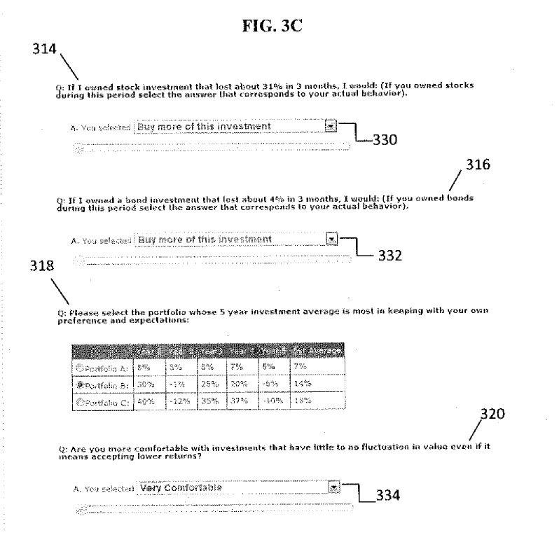

The risk assessment module 110 may be communicatively linked to the database 106 and may store asset owner preferences. The asset owner preferences may comprise any preferences of the asset owner related to risk tolerance and/or financial goals. For example, the asset owner preferences may comprise information related to the assets owner's attitude toward economic trends, tolerance for gain and/or loss in asset value, and/or financial strategy in terms of time to retirement, age, income sources and the like, as further discussed below with respect to FIG. 3.

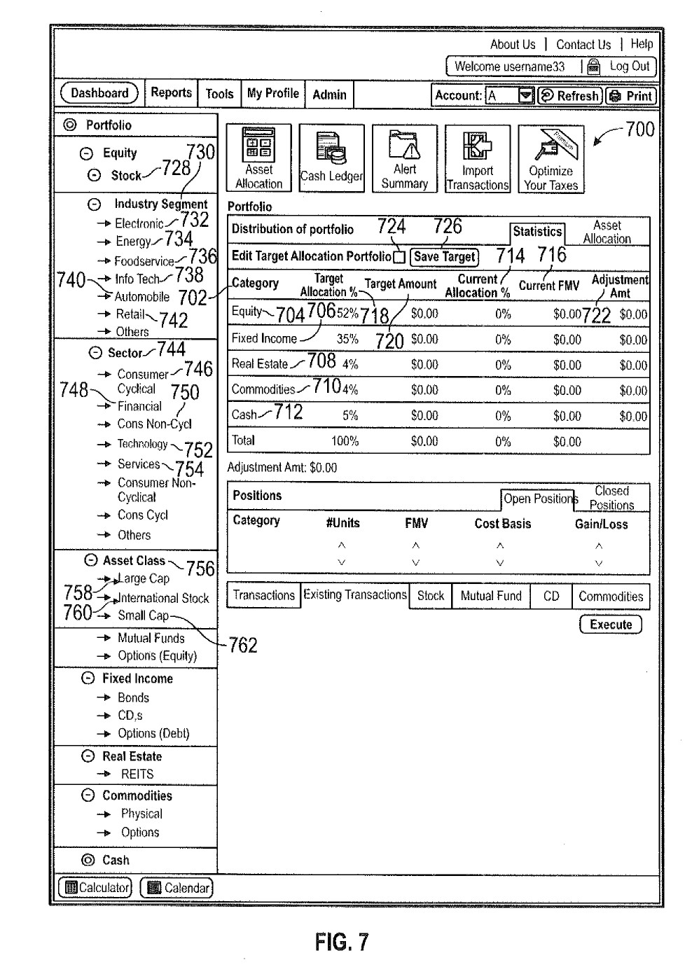

In one embodiment, according to various aspects of the present invention, the financial advisory system 100 may comprise an asset allocation engine 112. The asset allocation engine 112 may perform any suitable processing of the asset data 108 to produce an existing asset allocation scheme. The existing asset allocation scheme may comprise a breakdown of asset classes, industry segments, and/or sectors applicable to the asset data 108. For example, the existing asset allocation scheme may illustrate the percentage of assets in asset data 108 that belong to different asset classes such as stocks, bonds, and cash equivalents. In one embodiment, the existing asset allocation scheme may provide information about the percentage of assets in asset data 108 that belong to particular industry segments and sectors, as further discussed below with respect to FIG. 7.

In an exemplary embodiment, asset allocation engine 112 may generate a target asset allocation model comprising the optimal allocation of assets to comport with the risk tolerance and financial goals provided in the asset owner preferences in the risk assessment module 110, market trends, and information related to the quality of the investments in the asset data 108. In one embodiment, the asset allocation engine 112 may analyze data stored and/or retrieved by the database 106 relating to market trends. For example, market trends may correspond to data from one or more authoritative sources, such as governmental regulatory bodies and/or professional organizations. In one embodiment, an authoritative source may comprise the Jobless Claims Report released weekly by the U.S. Department of Labor, the money supply released by the Federal Reserve as an indicator of inflation, the New Residential Housing Construction Report (also referred to as housing starts) released by the Census Bureau and the Department of Housing and Urban Development (HUD), and/or the Consumer Confidence Index (CCI) released by the Conference Board and the like.

In another embodiment, the asset allocation engine 112 may analyze data retrieved by the database 106 relating to the quality of the assets in the asset data 108. The quality of the assets may refer any indicator of the performance of an asset, such as a company's stock earning a high rate of return or the creditworthiness of the company. For example, the asset allocation engine 112 may review ratings of the asset, such as the Schwab Equity Rating provided by Charles Schwab & Co, Inc., and/or Standard & Poor's credit rating of equities. In one embodiment, the asset allocation engine 112 may recommend that the user 102 dispose of low quality assets and replace them with higher quality assets. Exchanging assets may not change the percentage of the allocation of assets in different asset classes, industry segments, and/or sectors, but may increase the quality of the assets in the investment portfolio.

In some embodiments, the asset allocation engine uses variables assigned to the risk assessment module 110 to determine an appropriate allocation model (for the user), as will be discussed in detail below. Based on the results from the risk assessment module 110, the target asset allocation may be calculated.

The asset allocation engine 112 may compare the existing asset allocation scheme to the target asset allocation model to identify deficiencies. In one embodiment, a deficiency may comprise an asset to be acquired or disposed of to modify the existing asset allocation scheme to achieve the target asset allocation model. For example, in one embodiment, a user 102 may be over allocated in stocks and under allocated in fixed income. But after the target allocation model compared to existing asset allocation, the allocation engine 112 will show a deficiency and suggest a reduction of stocks and an increase in fixed income, as will be further discussed below with respect to FIG. 7.

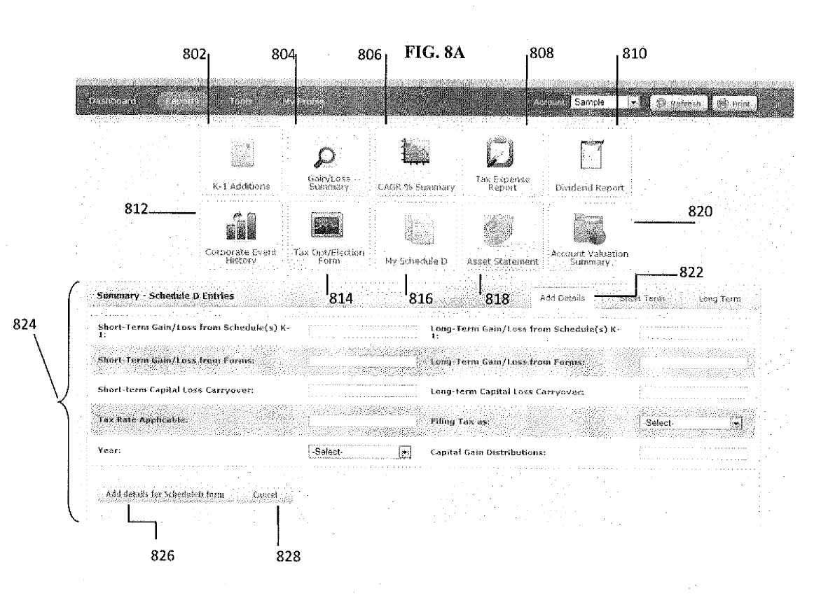

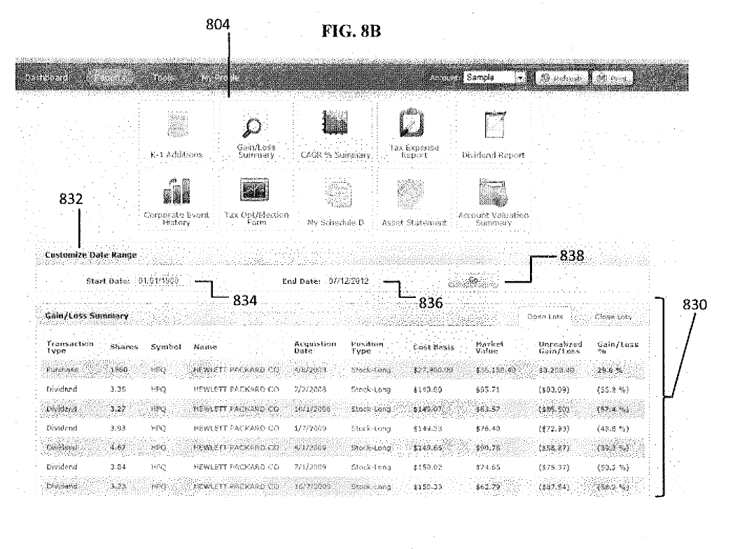

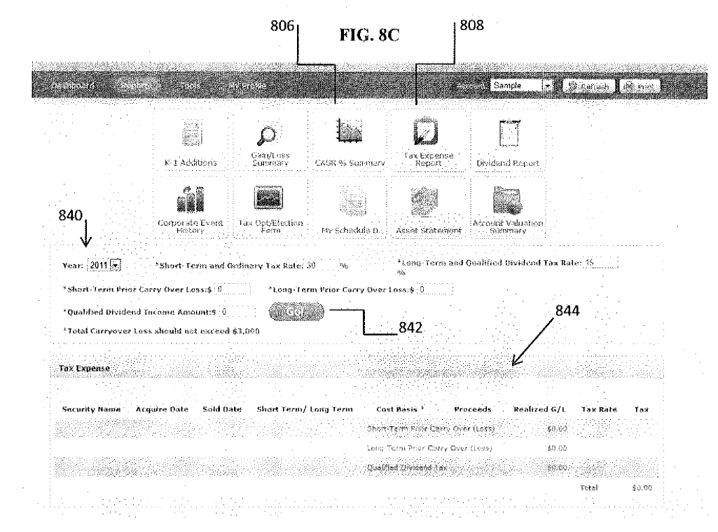

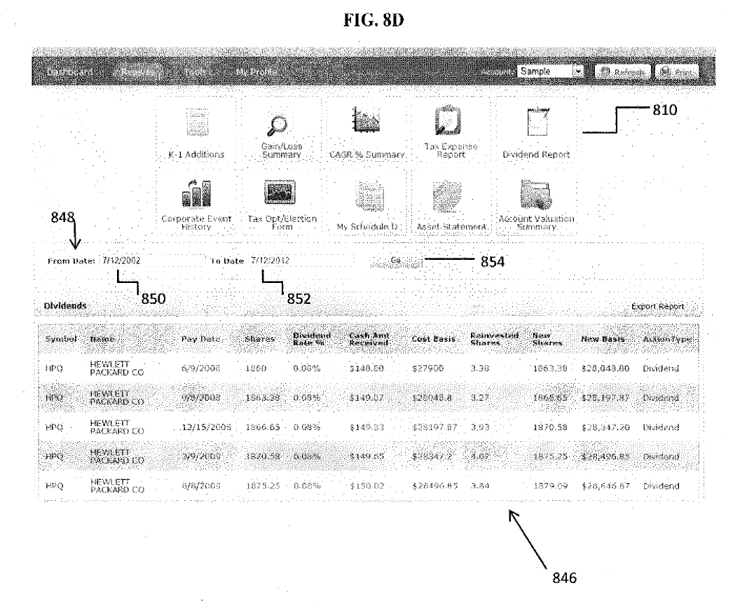

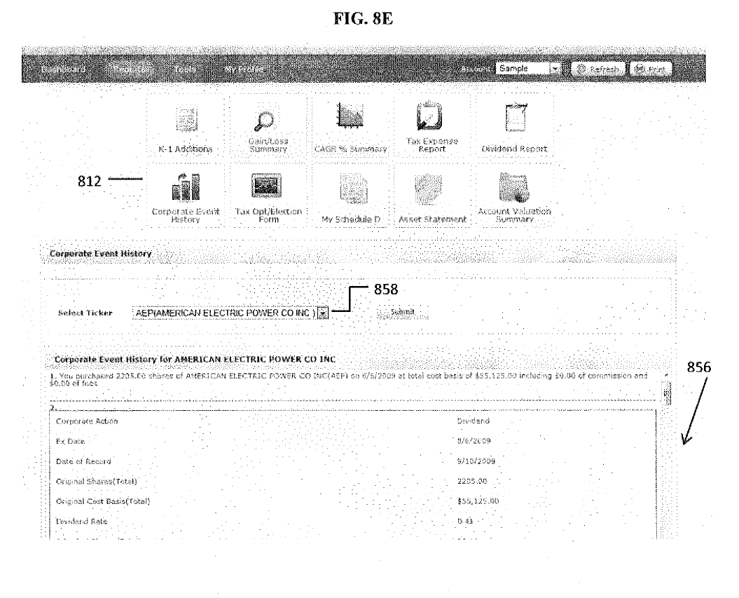

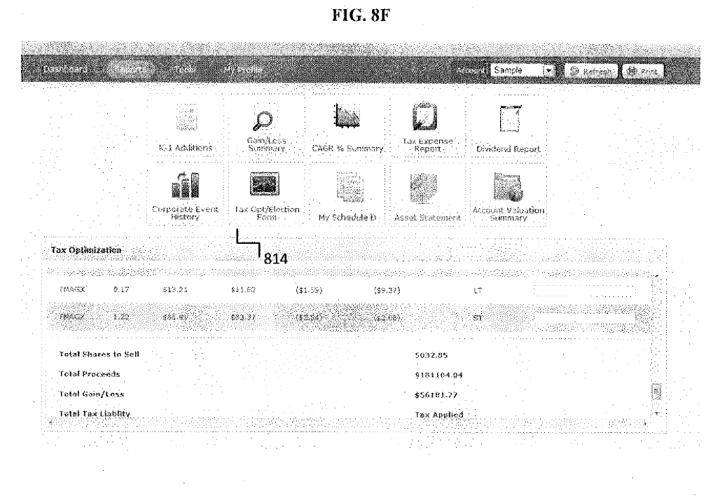

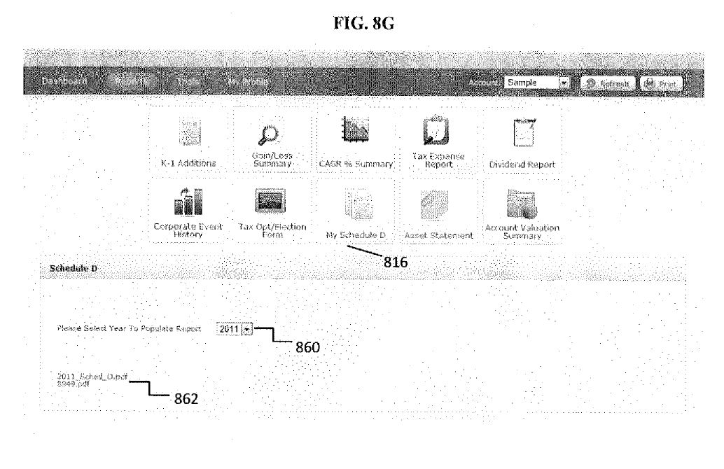

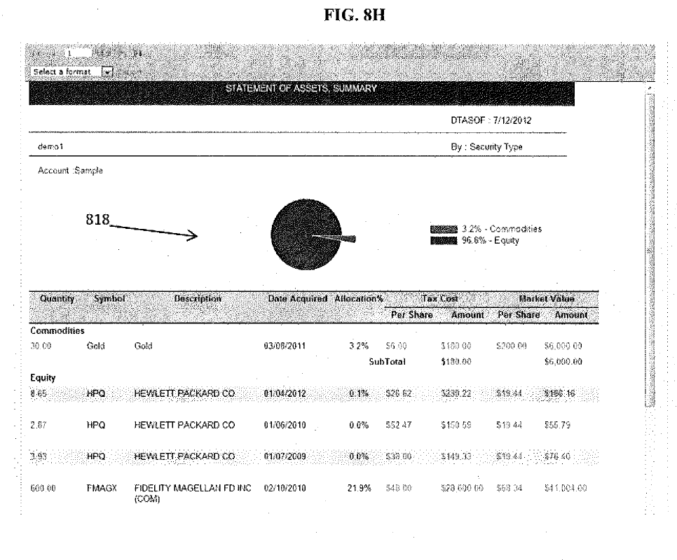

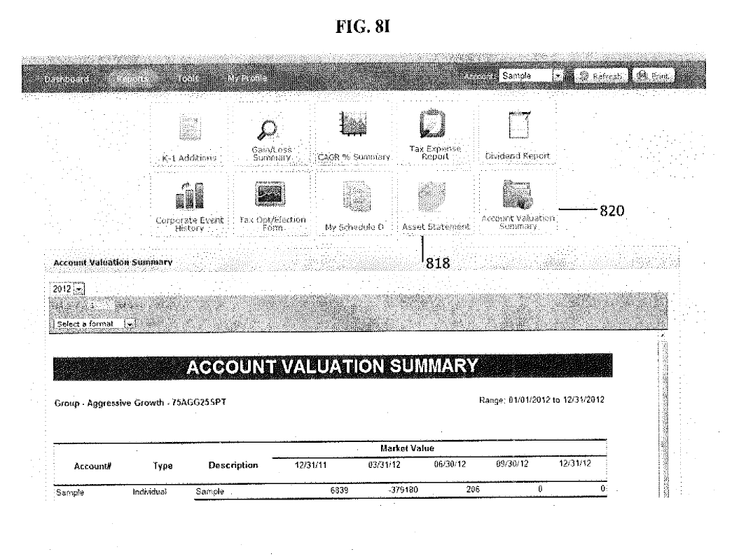

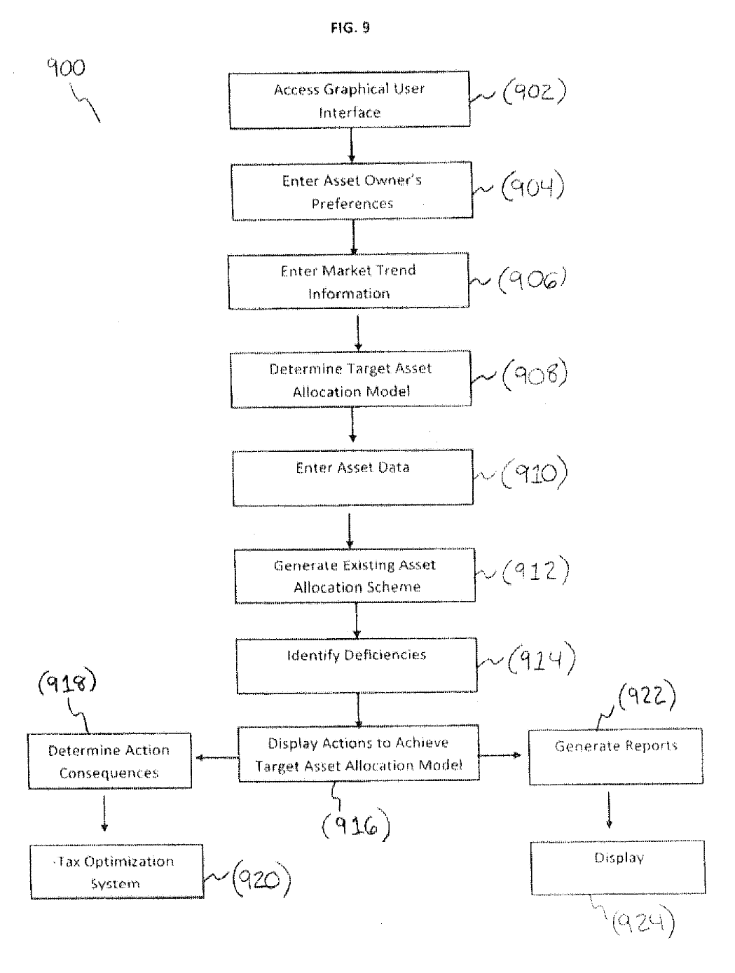

In some embodiments, the financial advisory system 100 may comprise a report module 118. The report module 118 may comprise a report made using the asset data 108 and/or the analysis performed by the asset allocation engine 112. For example, the report module 118 may comprise tax reports, reports relating to changes in asset value, dividend reports, and investment performance reports, as further discussed below with respect to FIG. 8.

In one embodiment, according to various aspects of the present invention, the financial advisory system 100 may display the asset to be sold to achieve the financial goals input by the user 102 on a display 120. In one embodiment, as discussed in further detail below with regard to FIGS. 7 and 8, the display 120 may indicate the allocation of asset class, industry segment, and/or sector of the assets from asset data 108. The display 120 may indicate the current allocation of assets, the target allocation of assets and value information.

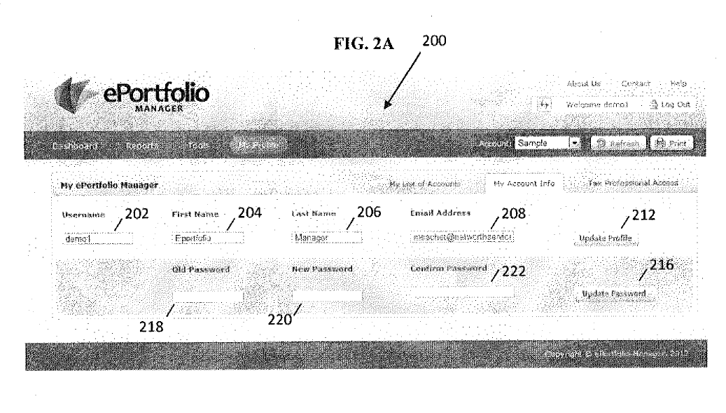

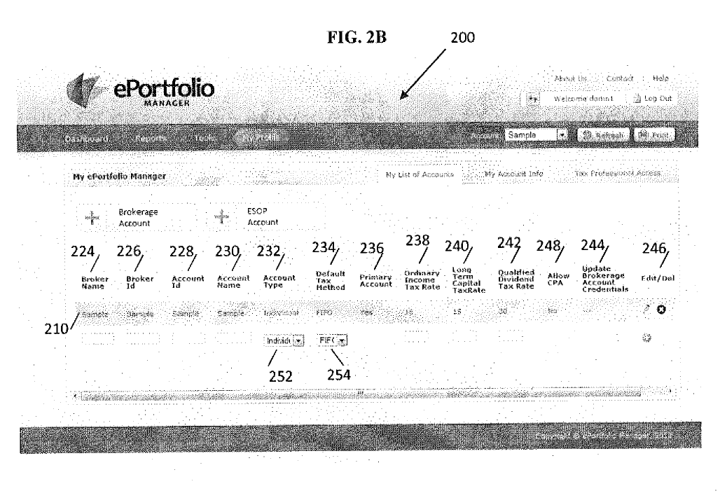

In some embodiments, referring to FIGS. 2A and 2B, the user 102 may manage different accounts within the financial advisory system 100 in a user profile module 200. The user 102 may access the user profile module 200 and any other module and/or displays of the financial advisory system 100 through the graphical user interface 104. Referring to FIG. 2A, the user 102 may enter identifying information in a personal profile by entering a username 202, first name 204, last name 206, and/or email address 208. The user 102 may save the personal profile to the database 106 by selecting an update profile button 212. In the event that the profile information changes, the user 102 may enter new personal profile information and then select the update profile button 212 to save the new information to the database 106.

The user 102 may change a password to securely access the financial advisory system 100 by entering an old password 218, a new password 220, and enter the new password 220 again in confirm password 222. The user 102 may select the update password button 216 to save the new password 220 to the database 106.

The user 102 may identify information for one or more accounts at various investment brokerage firms. For example, referring to FIG. 2B, the user 102 may designate information for an account. The user 102 may have any number of accounts. In one embodiment, each account may be edited or deleted 246 according to changes needed by the user 102. For each account, the user 102 may enter a broker name 224 and/or a broker identification symbol 226. The user 102 may also designate an account name 230 and/or an account identifier 228 for distinguishing between the accounts at the same brokerage firm. In one embodiment, the user 102 may designate the account type 232 such as an individual account, a corporate account, a limited partnership account, and/or an account with a purpose such as a custodial account or college account and the like. For example, the account type 232 may comprise an account type drop down menu 252 with multiple options. The possible responses may include, but are not limited to individual, joint, trust, corporate, individual retirement account (“IRA”), and Roth IRA.

In some embodiments, the user 102 may enter the brokerage account credentials 244 to track and update the qualifications of each brokerage firm. In one embodiment the brokerage account credentials 244 may comprise security and password details. In one embodiment, the brokerage account credentials 244 may comprise accreditations with the Accredited Estate Planner (AEP), Accredited Tax Advisor (ATA), Accredited Tax Preparer (ATP), Certified Annuity Advisor (CAA), Chartered Financial Analysts (CFA), Certified Fund Specialists (CFS), Investment Management Consultants Association (CIMA), and/or any one of a wide variety of credentials a financial advisor may obtain.

In some embodiments, the user 102 may designate a default tax method 234 that may apply to each account 210. For example, the default tax method 234 may comprise a tax method drop down menu 254 with multiple options. In one embodiment, the default tax method 234 may comprise a first in first out (FIFO) option, where the first tax lots purchased by date would be sold first. In another embodiment the default tax method 234 may comprise a last in first out (LIFO) option, where the last tax lots purchased by date would be chosen. In another embodiment, the default tax method 234 may comprise a specific option, where the user 102 can specifically choose the tax lots and/or sort the tax lots as desired. In another embodiment, the default tax method 234 may comprise an average single option, where the short-term and long-term tax lots are combined. In another embodiment, the default tax method 234 may comprise an average double option, where short term tax lots are averaged and long-term tax lots are averaged and presented separately. In another embodiment, the default tax method 234 may be a highest first out (HIFO) option, where the highest cost basis tax lots are sold first. In yet another embodiment, the default tax method 234 may comprise a lowest first out (LOFO) option, where the lowest cost basis tax lots are sold first. In another embodiment, the default tax method 234 may comprise an all option where each of the above options is chosen.

In some embodiments, the user 102 may further select whether each account name 230 is a primary account 236 in the user profile module 200. For example, the primary account 236 may be an account that has the largest value and/or the account the asset owner uses regularly. In one embodiment, the primary account 236 may be a user's household account. In one embodiment, the primary account 236 may be a user's business account.

In some embodiments, according to various aspects of the present invention, the user 102 may further indicate various designated tax rates on each account, such as an ordinary income tax rate 238, a long term capital tax rate 240, and/or a qualified dividend tax rate 242. The tax rate information may be used by the tax optimization system 116 to calculate the tax in the event an asset from the account name 230 is sold.

In some embodiments the financial advisory system 100 may comprise the risk assessment module 110. In one embodiment, referring to FIGS. 3A-3C, the user 102 may enter the asset owner's preferences related to risk tolerance and/or financial goals in the risk assessment module 110 within. the financial advisory system 100. The risk assessment module 110 may comprise any questions related to the assets owner's attitude toward economic trends, tolerance for gain and/or loss in asset value, and/or the asset owner's financial strategy in terms of time to retirement, age, income sources and the like. The information entered into the risk assessment module 110 may be analyzed by the asset allocation engine 112 to generate a target asset allocation model based on the asset owner's preferences, as described in detail below.

In some embodiments, the risk assessment module 110 may comprise various questions for the user 102 to answer. For example, in an exemplary embodiment, the user 102 may enter information the asset owner's attitude about the U.S. economy 302. The user may enter this response via a drop down menu 304. The possible responses may include, but are not limited to very negative, somewhat negative, neutral, somewhat positive, and very positive. The risk assessment module 110 may also comprise questions about the time frame in which the asset owner prefers to meet a financial goal 306. The user may enter this response via a drop down menu 322. The possible responses may include, but are not limited to 1 to 3 years, 3 to 5 years, 5 to 10 years, 10 to 15 years, and more than 15 years. The risk assessment module 110 may also comprise questions about the stability of income sources 308 of the asset owner. The user may enter this response via a drop down menu 324. The possible responses may include, but are not limited to very unstable, unstable, somewhat stable, stable, and very stable. The risk assessment module 110 may also comprise questions about whether the asset owner believes his or her income will keep pace with inflation 310. The user may enter this response via a drop down menu 326. The possible responses may include, but are not limited to decrease, keep pace, and increase. The risk assessment module 110 may also comprise questions about how conservatively or aggressively the asset owner would want assets invested if a professional money manager had complete discretion over the asset owner's portfolio 312. The user may enter this response via a drop down menu 328. The possible responses may include, but are not limited to conservatively, moderately conservative, moderate, moderately aggressive, and aggressively.

In some embodiments, the risk assessment module 110 may comprise questions related to what action, if any; the asset owner may take in response to an event. In one embodiment, the risk assessment module 110 may comprise questions about whether the asset owner would keep or sell a stock that decreased in value substantially 314. The user may enter this response via a drop down menu 330. The possible responses may include, but are not limited to buy more of this investment, hold on to this investment, sell some of the investment, sell most of the investment, and sell all of the remaining investment. In one embodiment, the risk assessment module 110 may comprise questions about whether the asset owner would keep or sell a bond that decreased in value substantially 316. The user may enter this response via a drop down menu 332. The possible responses may include, but are not limited to buy more of this investment, hold on to this investment, sell some of the investment, sell most of the investment, and sell all of the remaining investment.

In one embodiment, the risk assessment module 110 may display examples of portfolio performances ranging in short term and long term gains and losses in value and request that the user 102 select which portfolio is within the asset owner's preferences and expectations 318. In another embodiment, the risk assessment module 110 may comprise a question about whether the asset owner is comfortable with an investment with little change in value that results in lower returns 320. The user 102 may save the information entered into the risk assessment module 110 into the database 106 by selecting the submit button.

In some embodiments, the asset allocation engine uses variables assigned to the risk assessment module 110 to determine an appropriate allocation model (for the user), as will be discussed in detail below. Based on the results from the risk assessment module 110, the target asset allocation may be calculated. As described above, there are multiple questions 302, 306, 308, 310, 312, 314, 316, and 320 that are designed to assess the asset owner's preferences. The answers 304, 322, 324, 326, 328, 330, 332, and 334 to the questions are then evaluated to create an acceptable allocation model. The answers 304, 322, 324, 326, 328, 330, 332, and 334 to the questions are assigned quantitative values that indicate the asset owner's preferences. For example in the risk question, “In general what is you attitude towards the US Economy”, the response is assigned a numerical value: 1 for Very Negative, 2 for Somewhat Negative, 3 for Neutral, 4 for Somewhat Positive and 5 for Very Positive. The total of all the risk assessment questions is calculated and based on the total, the acceptable allocation is selected. The high the score, the more risk tolerant is the user and the lower the score, the less risk tolerant is the user.

In some embodiments, the acceptable allocation model may comprise options of a very low risk tolerance, a moderately low risk tolerance, a moderate risk tolerance, a high risk tolerance, and a very high risk tolerance. In one embodment, when given quantities values, the very low risk tolerance may be from 1-10, the moderately low risk tolerance may be from 11-20, the moderate risk tolerance may be 21-30, the high risk tolerance may be from 31-40, and the very high risk tolerance may be from 41-50. In one embodiment, very low risk tolerance may indicate that even in bull markets, the asset owner seeks risk adverse decisions. The very low risk tolerance may be highly cautious approach an asset owner who wants liquid income and a stable investment. In one embodiment, the moderately low risk tolerance may comprise an asset owner that seeks consistent and dependable income with a modest potential for growth. In one embodiment, the moderate risk tolerance may comprise an asset owner that wishes to minimize risk with stable stocks to balance high risk stocks for long term investors with potential for growth but less volatility than the market. In one embodiment, the high risk tolerance may comprise an asset owner that is focused on long term investment with growth potential in a volatile market. In one embodiment, the very high risk tolerance may comprise an asset owner that is focused on high return long term investments.

Once the acceptable allocation model is assessed, the risk assessment module 110 along with the asset allocation engine 112 may calculate the target asset allocation.

In some embodiments the financial advisory system 100 may comprise an asset data upload module. In one embodiment, the user 102 may enter asset data 108 in the asset data upload module to be saved in the database 106 within the financial advisory system 100. In one embodiment, the user 102 may import asset data 108 in the asset data upload module to be saved in the database 106 within the financial advisory system 100. Any electronic file comprising financial data may be entered or imported into the asset data upload module. For example, an open financial exchange (OFX) file may be selected to be uploaded into the asset data upload module. The OFX file may comprise an open standard unified specification for the exchange of electronic financial data between financial software programs, financial institutions, and businesses. In one embodiment, the OFX file may be created in a financial program such as Google Finance, Quicken, and/or Microsoft Money software and the like. In one embodiment, the user 102 may select the electronic file containing the asset data 108 by searching for the file from any source storing the file, such as a hard drive, USB device, and/or internet source and the like.

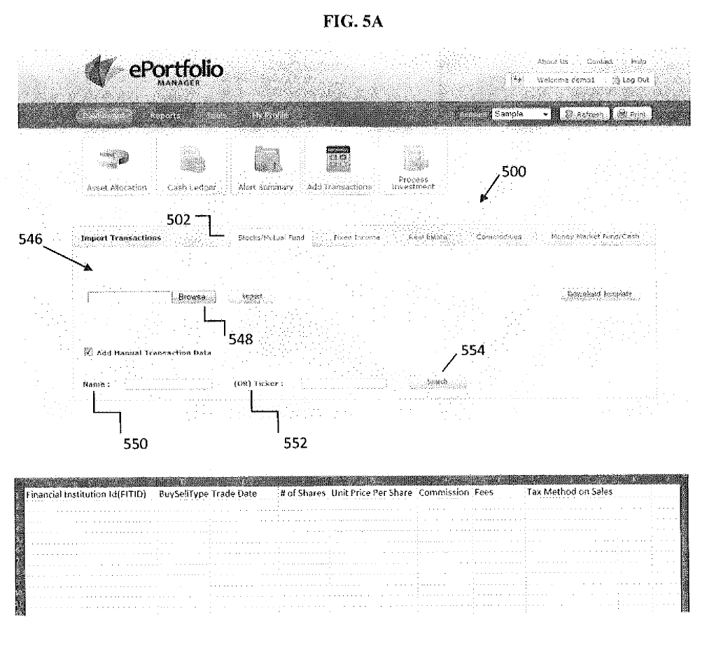

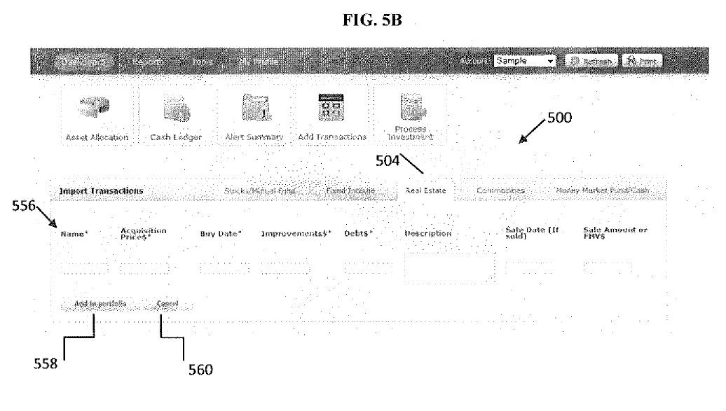

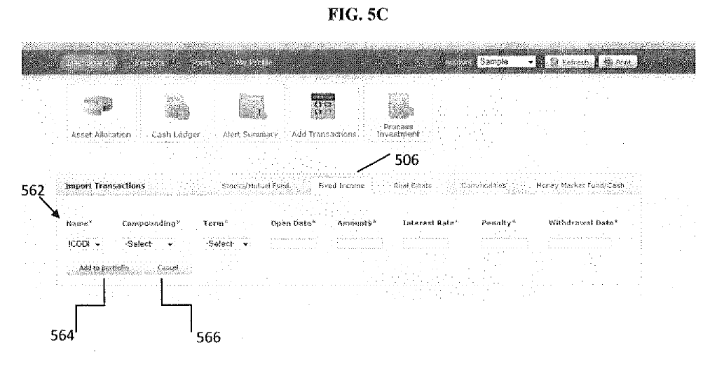

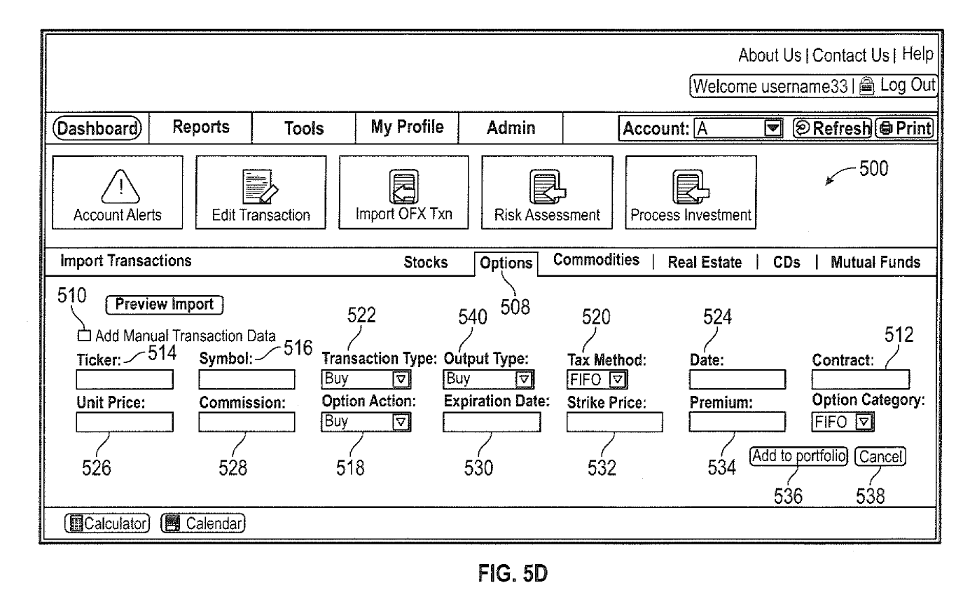

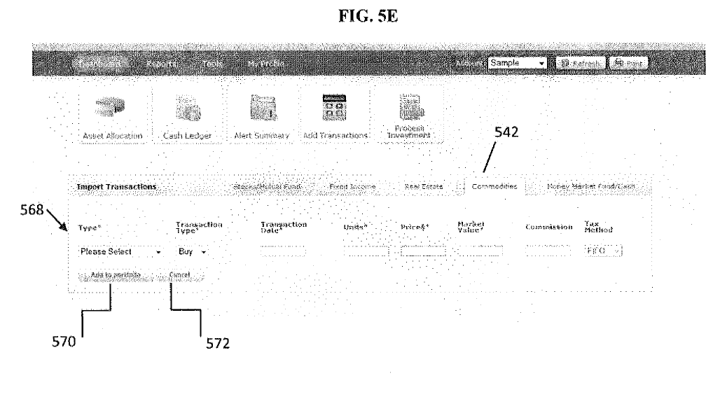

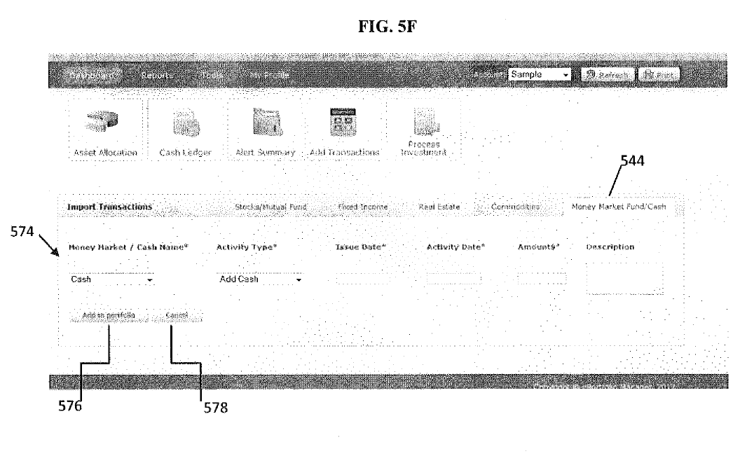

In some embodiments, the financial advisory system 100 may comprise an asset data manager module 500. In one embodiment, of the present invention, the asset data 108 that may be entered by the user 102 into the asset data upload module may be sorted and viewed through the asset data manager module 500 within the financial advisory system 100. In one embodiment, the asset data manager module 500 may import asset data 108 from the asset data upload module. In some embodiments, referring to FIGS. 5A-5F, the asset data manager module 500 may comprise a stock module 502, a real estate module 504, a fixed income module 506, an options module 508, a commodities 542 module, and a money mark fund/cash module 544. The stock 502 module, real estate module 504, fixed income 506, module, the options module 508, the commodities module 542, and the money mark fund/cash module 544 may import asset data 108 from the asset data upload module.

In some embodiments, the user 102 may enter specific data relating to asset data 108 into the asset data manager module 500 to be saved in the database 106. For example, referring to FIG. 5D, the user 102 may enter option information into the asset data manager module 500 by selecting the manual transaction data button 510. The option information may comprise any security identified by a ticker symbol 514 and/or a stock symbol 516 that the asset owner has the right to buy, such as through an employment or other contract 512. In some embodiments, the user 102 may enter the option action 518 such as an option to buy the security (call option) or to sell the security (put option). In various embodiments, the user 102 may enter the tax method 520, as described above in relation to FIG. 2B, the transaction type 522, such as buy or sell, the date of the transaction 524, the price of the option 526, and a commission amount 528 resulting from the transaction, if any. The user 102 may also enter the expiration date 530 of the option contract. In one embodiment, the user 102 may add the strike price 532 for the fixed price indicated in the option contract 512 for buying or selling the security. The user 102 may also indicate the premium 534. The premium 534 may represent the market value of the options contact, which may be influenced by the volatility of the security and/or prevailing interest rates. The user 102 may select the add to portfolio button 536 to upload the option information into the database 106 or may delete the information if needed by selecting the cancel button 538.

In some embodiments, referring to FIG. 5A, the user 102 may import stock information 546 in the stock module 502. In one embodiment, the user 102 may import stock information 546 from the database 106 by using the browse tab 548 In one embodiment, the user 102 may import stock information 546 by searching for a stock name 550 or a stock symbol 552 and selecting a search tab 554. Once the user selects the stock, either via the browse tab 548 or the search tab 554, the stock information 546 will be imported in the stock module 502. In some embodiments, the stock information 546 may comprise the stock symbol 552, the stock name 550, a transaction type, a transaction date, number of units, unit price, commission, fees, and tax method.

In some embodiments, referring to FIG. 5B, the user may import real estate information 556 in the real estate module 504. The user 102 may enter a portion of the real estate information 556 to populate the real estate module 504 with the remainder of the real estate information 556. The user 102 may enter a portion of the real estate information 556 or all of the real estate information 556. In one embodiment, the user 102 may import the real estate information 556 by selecting security or brokerage account information. In one embodiment, the user may manually enter the real estate information 556. The real estate information 556 may comprise a name, an acquisition price, a buy date, improvements, debt, description, sale date, and sale amount or fair market value (FMV). The FMV may comprise the current estimated value of the real estate. The user may add to the user's portfolio by selecting the add to portfolio button 558 or may cancel 560.

In some embodiments, referring to FIG. 5C, the user may import fixed income information 562 in the fixed income module 506. The user 102 may enter a portion of the fixed income information 562 to populate the fixed income module 506 with the remainder of the fixed income information 562. The fixed income information 562 may comprise a name, compounding period, a term, open date, amount, interest rate, penalty, and withdrawal date. In one embodiment, the name may comprise a drop down menu comprising a security name or symbol. In one embodiment, the compounding period may comprise a drop down menu comprising the following options annual, semi annual, quarterly, monthly, or daily. In one embodiment, the term may comprise a drop down menu comprising the following options 3 months, 6 months, 9 months, 12 months, 18 months, 3 years, 4 years or 5 years. The user may add to the user's portfolio by selecting the add to portfolio button 564 or may cancel 566.

In some embodiments, referring to FIG. 5E, the user may import commodities information 568 in the commodities module 542. The user 102 may enter a portion of the commodities information 568 to populate the commodities module 542 with the remainder of the commodities information 568. The commodities information 568 may comprise a commodities type, a transaction type, a transaction date, number of units, unit price, commission, and tax method. The commodities type may comprise a drop down menu comprising options including but not limited to agriculture, bens, energy, gold, industrial metals, livestock & meat, other, precious metals, or rare metals. The transaction type may comprise a drop down menu comprising the options of by or sell. The tax method may comprise a drop down menu comprising the following options FIFO, LIFO, HIFO, LOFO as described in detail above. The user 102 may add to the user's portfolio by selecting the add to portfolio button 570 or may cancel 572.

In some embodiments, referring to FIG. 5F, the user may import/enter money mark fund/cash information 574 in the money mark fund/cash module 544. The user 102 may enter a portion of the money mark fund/cash information 574 to populate the money mark fund/cash module 544 with the remainder of the money mark fund/cash information 574. The money mark fund/cash information 574 may comprise a name, an activity type, an issue date, an activity date, amount, and a description. The name may comprise a drop down menu comprising cash or money market. The activity type may comprise a drop down menu comprising the options of add cash, withdraw cash or corporate action-cash activity. The user may add to the user's portfolio by selecting the add to portfolio button 576 or may cancel 578.

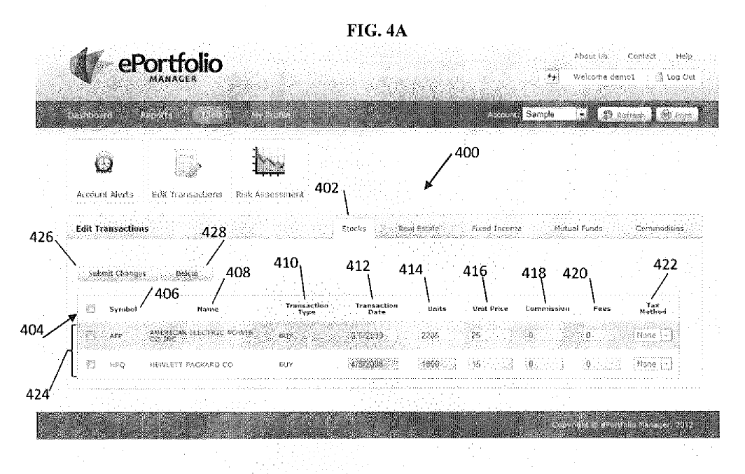

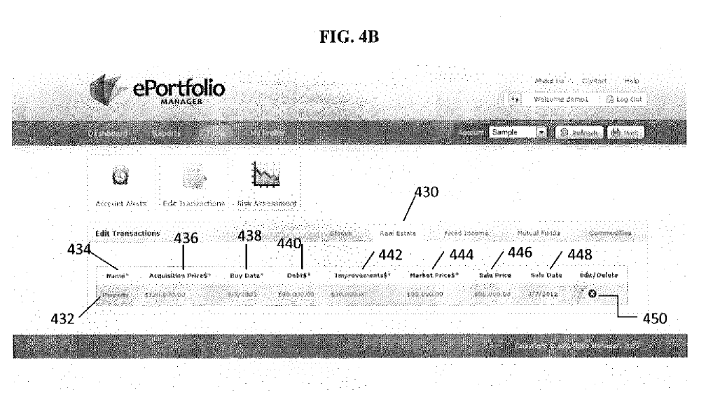

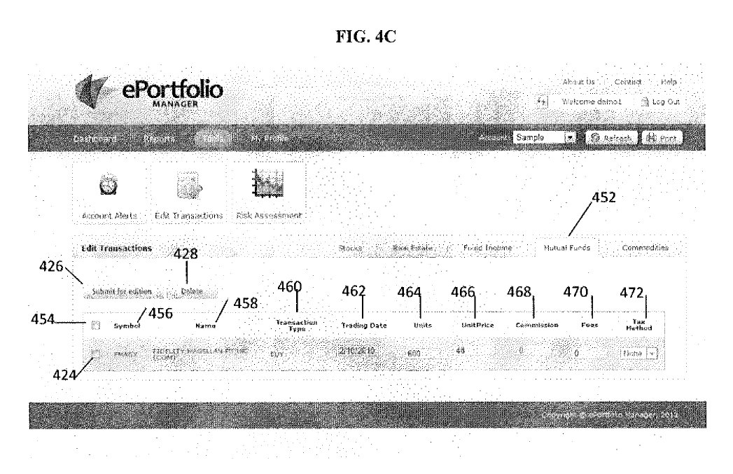

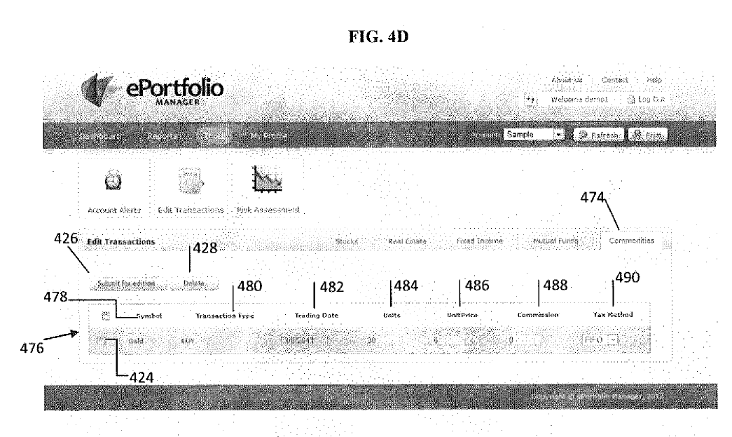

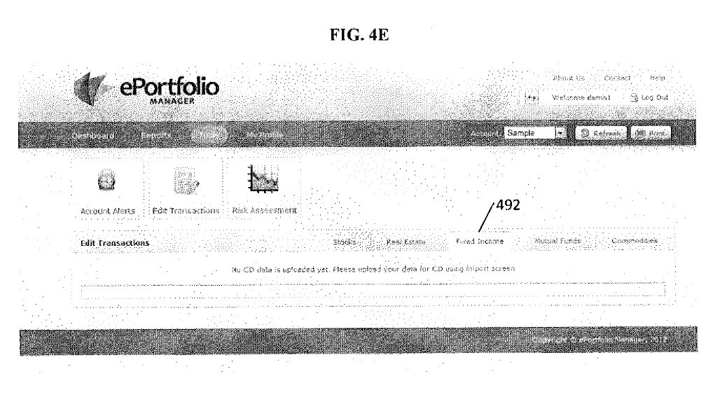

In some embodiments, the financial advisory system 100 may comprise an edit transaction module 400. In one embodiment, the asset data 108 entered into the asset data upload module may be edited in the edit transaction module 400 within the financial advisory system 100. The edit transaction module 400 may allow the user 102 to edit the specific data relating to asset data 108 from the asset data manager module 500. In one embodiment, referring to FIGS. 4A-4E, the edit transaction module 400 may display a stock module 402, a real estate module 430, a mutual funds module 452, a commodities module 474, and fixed income module 492 for the user 102 to edit.

In some embodiments, the user 102 may edit specific data relating to asset data 108 into the edit transaction module 400 to be saved in the database 106. Referring to FIG. 4A, the user may edit stock information 404 in the stock module 402. The stock information 404 may comprise a stock symbol 406, a stock name 408, a transaction type 410, a transaction date 412, number of units 414, unit price 416, commission 418, fees 420 and tax method 422. The tax method 422 may comprise FIFO, LIFO, HIFO, and LOFO as described in detail above. The user 102 may check a box 424, to edit the stock information 404. Once the user 102 has edited the stock information 404, the user 102 may select the submit changes button 426. Alternatively, the user 102 may delete the stock information 404 by selecting the delete button.

Referring to FIG. 4B, the user 102 may edit real estate information 432 in the real estate module 430. The real estate information 432 may comprise a name 434, an acquisition price 436, a buy date 438, a debt 440, improvements 442, market price 444, sale price 446, and sale date 448. The user 102 may check the edit/delete option 450 for the desired action.

Referring to FIG. 4C, the user 102 may edit mutual fund information 454 in the mutual fund module 452. The mutual fund information 454 may comprise a mutual fund symbol 456, a mutual fund name 458, a transaction type 460, a trading date 462, number of units 464, unit price 466, commission 468, fees 470 and tax method 472. The tax method 472 may comprise a drop down menu with the options of FIFO, LIFO, HIFO, and LOFO, as described in detail above. The user 102 may check a box 424 to edit the mutual fund information 454. Once the user 102 has edited the mutual fund information 454, the user 102 may select the submit changes button 426. Alternatively, the user 102 may delete the mutual fund information 454 by selecting the delete button.

Referring to FIG. 4D, the user 102 may edit commodities information 476 in the commodities module 474. The commodities information 476 may comprise a commodities symbol 478, a transaction type 480, a trading date 482, number of units 484, unit price 486, commission 488, and tax method 490. The tax method 490 may comprise a drop down menu with the options of FIFO, LIFO, HIFO, and LOFO, as described in detail above. The user 102 may check a box 424 to edit the commodities information 476. Once the user 102 has edited the commodities information 476, the user 102 may select the submit changes button 426. Alternatively, the user 102 may delete the commodities information 476 by selecting the delete button 428.

Referring to FIG. 4E, the user 102 may edit fixed income information 494 in the fixed income module 492. When the user 102 enters the fixed income module 492, the user 102 will be able to view any CD or fixed income currently in the account to select and edit.

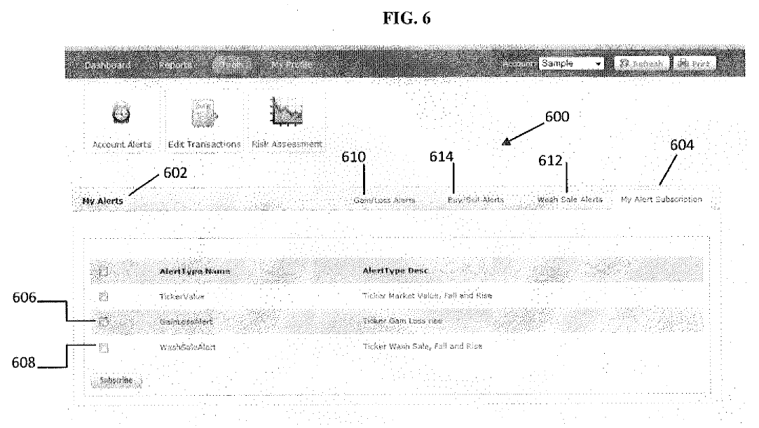

In an exemplary embodiment of the present invention, the user 102 may view an alert 602 (actual alert not shown) related to the asset data 108 in the alert display 600 via the display 120 within the financial advisory system 100, as shown in FIG. 6. The alert 602 may be based on the asset owner's preferences entered into the risk assessment module 110 and/or the status of the value and/or capital events relating to assets in the asset data 108. In one embodiment, the database 106 may retrieve information related to the asset data 108 from a security database (not shown). One or more security databases may be stored in the database 106 and/or be accessible through the internet. For example, the security database may comprise a source with information related to the security, such as any domestic or regional stock exchange (e.g., New York Stock Exchange (NYSE) and National Association of Securities Dealers Automated Quotation (NASDAQ)). The security database may also comprise historical price information about the asset data 108, such as a high price, low price, and/or an open price for the security on any day. The security database may also store information identifying capital events that have occurred over a given period of time in connection with the various securities. The capital events may comprise, for example, spin-offs, mergers, stock splits, rights offerings, right redemptions, special dividends, return capital, original issue discounts and dividend reinvestments. The security database may comprise the capital events for the plurality of different securities. For each capital event stored in the security database, the security database may store a field corresponding to a name of a company associated with the capital event, a stock symbol associated with the capital event, a date of the capital event, a type (e.g., dividend reinvestment, stock split, spin-off, etc.) of the capital event, a shares held adjustment ratio associated with the capital event, and any other information desired to be associated with the capital event. Any suitable database structure may be used to store information identifying the capital events.

In one embodiment, the alert display 600 may be customized by the user 102 by selecting a my alert subscription option 604. The my alert subscription option 604 may comprise options such as, for example, ticker values, gain/loss, buy/sell, wash sale, and the like. For example, to customize the alert display, the user 102 may simply select a box for gain loss alert 606 and wash sale 608, and the corresponding gain loss alert tab 610 and wash sale tab 612 appear on the alert display 600. The alert display 600 may also display a buy sell alert tab 614, which may comprise the value of an asset and/or an alert to buy or sell an asset in the asset data 108 that was uploaded into the asset data upload module and/or entered into the asset data manager module 500. The user 102 may determine that an action should be taken, such as buying or selling an asset, based on the information in the alert display 600.

Referring now to FIGS. 7A and 7B, in one embodiment, the asset allocation engine 112 may present the existing asset allocation scheme and/or the target asset allocation model in the asset allocation display 700 via the display 120 within the financial advisory system 100. The asset allocation display 700 may show a category of assets 702 that the assets in the existing asset allocation scheme and/or the target asset allocation model belong. For example, the category of assets 702 may be equity 704. The equity 704 may represent ownership in any asset after debts are subtracted, such as the value of a security less any funds borrowed from the brokerage on a margin account. The category of assets 702 may also comprise fixed-income assets 706, such as bonds, real estate 708, commodities 710, and/or cash 712 including and cash equivalents such as money market funds.

In another embodiment, the user 102 may select to view a subcategory 728 of the equity 704, such as to view the percentage breakdown of the assets in the existing asset allocation scheme and/or the target asset allocation model into the different subcategories 728. For example, the user 102 may select to view the percentage of assets in the existing asset allocation scheme and/or the target asset allocation model in each industry segment 730 for industries such as electronics 732, energy 734, foodservice 736, information technology 738, automobile 740, and/or retail 742.

In another embodiment, the user 102 may view the percentage of assets in the existing asset allocation scheme and/or the target asset allocation model in each economic sector 744 such as cyclical consumer goods 746, non-cyclical consumer goods 750, financial services 748, technology, 752, and services 754. The user 102 may also view the asset class 756; referring to features of the equity 704 such as market capitalization value (the product of the number of a company's shares outstanding by the stock price per share). For example, the user 102 may select to see the allocation of assets in the existing asset allocation scheme and/or the target asset allocation model in large capitalization (large cap) 758 stocks and/or small capitalization (small cap) 762. The user 102 may also select to see the allocation of assets in international stocks 760.

In an exemplary embodiment of the present invention, the asset allocation display 700 may show a current allocation of assets 714 as a percentage of assets in the asset data 108 that fall into each category of assets 702. The current allocation of assets 714 may represent the existing asset allocation scheme of the asset data 108, as determined by the asset allocation engine 112. In one embodiment, the asset allocation display 700 may also present a current fair market value (FMV) 716 of the assets in each category of assets 702 for the current allocation of assets 714. This information may give the user 102 a clear picture of the breakdown of assets in the asset data 108 that belong to each category of assets 702. For example, the user 102 may see that the assets in the asset data 108 may be heavily weighted in one type of category of assets 702 and only moderately represented in others.

In an exemplary embodiment of the present invention, the asset allocation display 700 may show a target allocation percent 718 that may represent the percentage of assets in each category of assets 702. The target allocation percent 718 may represent the target asset allocation model generated by the asset allocation engine 112. In one embodiment, the asset allocation display 700 may also present a target amount 720 of the assets in each category of assets 702 for the target allocation percent 718. For example, the target amount 720 may represent a value, such as a dollar amount, of the assets in each category of assets 702. In one embodiment, by comparing the target amount 720 to the current FMV 716, the asset allocation display 700 may present an adjustment amount 722.

This information may give the user 102 a clear picture of the change that may need to be made to the existing asset allocation scheme to match the breakdown of the category of assets 702 in the target asset allocation model. For example, the user 102 may see that the adjustment amount 722 for the fixed-income 706 category of assets 702 may be “-$10,000” indicating that $10,000 of assets in that category of assets 702 should be sold. In another example, the adjustment amount 722 for equity 704 may be “$15,000” indicating that $15,000 in that category of assets 702 should be purchased. The adjustment amount 722 may give a relatively precise indicator of the action the user 102 may take to modify the existing asset allocation scheme to match the allocation of assets in the target asset allocation model.

In one embodiment, according to various aspects of the present invention, the user 102 may modify the values in the target allocation percent 718 and/or the target amount 720, such as by selecting the radio button for edit target allocation portfolio 724. The user 102 may then manually modify the values and save the new values to the database 106 by selecting the save target button 726.

Referring now to FIGS. 8A-8J, in some embodiments, the financial advisory system 100 may prepare various reports based on the needs of the user 102 and provide PDF format documents of the reports through the report module 118. For example, in one embodiment, the user 102 may select to sell an asset in the asset data 108 held in the asset owner's portfolio to comport with modifying the existing asset allocation scheme to match the assets in the target asset allocation model. Such a sale may have tax consequences. The tax optimization system 116 may assist the user 102 in identifying the optimal tax lots for the sale. In one embodiment, the user 102 may desire to view the tax consequences of the asset portfolio in any given year.

In some embodiments, the report module 118 may comprise a report selector 800 that allows the user 102 to select the type of report the user 102 wishes to view or produce. The report selector 800 may comprise a K-1 additions option 802, a gain/loss summary option 804, a compound annual growth rate (CAGR) summary option 806, tax expense report option 808, a dividend report option 810, a corporate event history option 812, a tax optimization option 814, a my schedule D option 816, an asset statement option 818, and an account valuation option 820.

Referring now to FIG. 8A, in one embodiment, the report selector 800 may comprise the K-1 addition option 802. The K-1 addition option 802 may comprise an add detail tab 822, which may allow the user 102 to enter K-1 form information 824 and upload the K-1 form information 824 into a schedule D tax form. K-1 forms are primarily generated from “pass through” entities such as: Limited Partnerships, Master Limited Partnerships, Partnerships or LLC's. The K-1 form information 824 may comprise a short term gain/loss from schedule K-1, a short term gain/loss from forms, a short term capital loss carryover, a tax rate, a year, a long term gain/loss from schedule K-1, a long term gain/loss from forms, a long term capital loss carryover, a tax filing, and a capital gain distribution. Once the user has input the K-1 form information 824, the user 102 may select add details to schedule D tab 826 to upload the information. Alternatively, the user 102 may cancel by selecting the cancel option 828.

Referring now to FIG. 8B, in one embodiment, the report selector 800 may comprise a gain loss summary option 804. The gain loss summary option 804 shows the current unrealized gain or lost (in both percentage and absolute) of each open and closed position. The unrealized gain or loss may be defined as the difference between the cost and the current market value the asset.

In one embodiment, the gain loss summary option 804 may provide summary information 830 for the gain and/or loss in value of the various assets in the asset data 108 during a customized date range 832 designated by the user 102. The gain loss summary option 804 may assist the user 102 in determining whether to sell an asset in asset data 108 in response to an alert from the alert display 600 and/or recommendations for the adjustment amount 722. The user 102 may enter the customized date range 832 comprising a start date 834 and an end date 836. The user 102 may then select the go option 838 and the gain loss summary option 804 will provide the summary information 830.

The gain loss summary option 804 shows the current unrealized gain or loss (in both percentage and absolute) of each open and closed position. The summary information 830 may comprise a transaction type, amount of shares, symbol, name, acquisition date, position type, cost basis, market value, unrealized gain/loss, and gain/loss percentage. The transaction type may comprise the option of buy or sell. The position type may comprise the option of stock/mutual fund, fixed income, real estate, commodities or cash.

In some embodiments, the report selector 800 may comprise the CAGR summary option 806. The CAGR summary option 806 may comprise a summary of the year-to-year growth of an asset over a specified period of time, assuming a steady rate of growth over that time. The CAGR summary option 806 shows the current unrealized gain or loss for each tax lot position. The CAGR summary option 806 may assist the user 102 in determining whether to sell an asset in asset data 108 in response to an alert from the alert display 600 and/or recommendations for the adjustment amount 722. The CAGR summary option 806 may inform an asset owner of the long term prospects of holding an asset by viewing the annualized gain or loss of the asset, but may not inform the asset owner of the short term changes in value that may have occurred over the specified time.

Referring now to FIG. 8C, the report selector 800 may comprise the tax expense report option 808. In one embodiment, tax expense report option 808 allows the user 102 to enter tax information 840 comprising a year, short term and ordinary tax rate, long tern and qualified dividend tax rate, short term carry over loss, long term carry over loss, and qualified dividend income amount. Once the user 102 has entered the tax information 840 the user may select the go option 842 and a tax expense report 844 will be displayed.

The tax expense report 844 may comprise a security name, acquired date, sold date, short term/long term status, cost basis, proceeds, realized gains or loss, tax rate and tax amount each of which are based on the tax information 840 entered by the user 102.

Referring now to FIG. 8D, in one embodiment, the report selector 800 may comprise the dividend report option 810. The dividend report option 810 displays the dividends received into the portfolio. The dividend report option 810 may comprise dividend summary information 846. The user 102 may enter the customized date range 848 comprising a start date 850 and an end date 852. The user 102 may then select the go option 854 and the dividend report option 810 of the report module 118 will generate the dividend summary information 846.

The dividend summary information 846 may comprise a symbol, name, pay date, amount of shares, dividend rate percent, cash amount received, cost basis, reinvested shares, new shares, new cost basis, and action type. The action type may comprise a dividend type, such as withdrawal or reinvestment.

In one embodiment, the dividend report option 810 may provide dividend summary information 846 for the dividends received for the various assets in the asset data 108 during customized date range 848 designated by the user 102. The dividend report option 810 may assist the user 102 in determining whether to sell an asset in asset data 108 in response to an alert from the alert display 600 and/or recommendations for the adjustment amount 722.

Referring now to FIG. 8E, in one embodiment, the user 102 may select the corporate event history option 812. The corporate event history option 812 may comprise corporate information 856 for each asset in the portfolio. The corporate information 856 may comprise all corporate action, event information, and history for each asset in the portfolio. Some examples of corporate information 856 comprise corporate action, expiration date, date of record, original total shares, original total cost basis, dividend rate, and the like. The user may simply select an asset from the drop down menu 858 to display the corporate information 856.

Referring now to FIG. 8F, in one embodiment, the user 102 may select the tax election option 814. This report function allows the user to input selected “Sell” transactions and lots and generate a tax relief letter to the client's investment advisor, broker dealer or tax preparer.

Referring now to FIG. 8G, in one embodiment, the user 102 may select a my schedule D option 816. The my schedule D option 816 allows the user 102 to download PDF reports in the report module 118. The user 102 may then select the year 860 of tax information to populate into a schedule D tax form 862 based on the facts of the sale. Referring to FIG. 8A, the schedule D tax form may 862 be populated manually by the user 102 entering K-1 form information 824 and/or the schedule D tax form 862 may be populated automatically by the financial advisory system 100. The user 102 may then download and print, transfer, file, and/or save the PDF document 862.

Referring now to FIG. 8H, in one embodiment, the user 102 may select the asset statement option 818. The asset statement option 818 displays a summary of positions held in the account. The asset statement option 818 allows the user 102 to store and view account statements from various accounts from custodians and brokerage firms.

Referring now to FIG. 8I, in one embodiment, the user 102 may select the account valuation option 820. The account valuation option 820 provides a summary valuation of all holdings. The account valuation option 820 allows the user to view a summary of all accounts within their portfolio(s).

### Method of Operation: FIG. 9

Referring to FIG. 9, a method of operation (900) according to various aspects of the present invention may comprise accessing the graphical user interface 104 by the user 102 (902). The user 102 may enter the asset owner's preferences into the risk assessment module 110 via the graphical user interface 104, such as the asset owner's attitude toward the economy, tolerance of changes in asset value, and/or long term financial goals and the like (904). Information relating to market trends may be retrieved by the database 106 (906). The asset allocation engine 112 may then generate the target asset allocation model based on the information entered into the risk assessment module 110 by the user 102 and the information relating to market trends retrieved by the database 106 (908). The user 102 may upload asset data 108 into the asset data upload module 500 (910). The asset allocation engine 112 may generate an existing asset allocation scheme based on the asset data 108 (912). The asset allocation engine 112 may analyze the difference between the existing asset allocation scheme and the target asset allocation model to identify deficiencies (914). The asset allocation display 700 may display actions needed to achieve the target asset allocation model (916).

Optionally, the user 102 may select for the financial advisory system 100 to evaluate the consequences of taking the actions needed to achieve the target asset allocation model, such as buying, selling, or moving assets (918). For example, the user 102 may select to sell the asset and may view the optimal tax lots for disposal, as determined by the tax optimization system 116 (920). The user 102 may also select for the report module 118 to generate a report, such as the schedule D 804 tax form, the gain loss term based summary 810, the CAGR summary 812, and/or the dividend summary 816 (922). The report may be viewed and/or downloaded by the user 102 through the display 120 (924).

The invention has been described with reference to specific exemplary embodiments. Various modifications and changes may be made, however, without departing from the scope of the present invention as set forth. The description and figures are to be regarded in an illustrative manner, rather than a restrictive one and all such modifications are intended to be included within the scope of the present invention. Accordingly, the scope of the invention should be determined by the generic embodiments described and their legal equivalents rather than by merely the specific examples described above. For example, the steps recited in any method or process embodiment may be executed in any appropriate order and are not limited to the explicit order presented in the specific examples. Additionally, the components and/or elements recited in any system embodiment may be combined in a variety of permutations to produce substantially the same result as the present invention and are accordingly not limited to the specific configuration recited in the specific examples.

Benefits, other advantages and solutions to problems have been described above with regard to particular embodiments. Any benefit, advantage, solution to problems or any element that may cause any particular benefit, advantage or solution to occur or to become more pronounced, however, is not to be construed as a critical, 11 required or essential features or components.

The terms “comprises”, “comprising”, or any variation thereof, are intended to reference a non-exclusive inclusion, such that a process, method, article, composition, system, or apparatus that comprises a list of elements does not include only those elements recited, but may also include other elements not expressly listed or inherent to such process, method, article, composition, system, or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

The present invention has been described above with reference to an exemplary embodiment. However, changes and modifications may be made to the exemplary embodiment without departing from the scope of the present invention. These and other changes or modifications are intended to be included within the scope of the present invention.

1. A financial advisory system for balancing an allocation of a plurality assets for an asset owner, comprising:
a graphical user interface configured to receive identifying information about the plurality of assets and a financial risk tolerance profile of the asset owner;
a database communicatively linked to the graphical user interface and configured to:
store the identifying information and the financial risk tolerance profile;
retrieve asset data from a repository database, the asset data comprising historical information about the plurality of assets; and
retrieve information about market trends from an authoritative source;
an asset allocation engine communicatively linked to the database and configured to:
generate an existing asset allocation scheme based on the plurality of assets;
generate a target asset allocation model, wherein the target asset allocation model comprises a recommended allocation of assets based on the financial risk tolerance and market trends; and
compare the existing asset allocation scheme to the target asset allocation model to identify a deficiency, wherein the deficiency comprises one or more assets to be at least one of acquired and disposed of to modify the existing asset allocation scheme to achieve the target asset allocation model;
a display configured to present at least one of the existing asset allocation scheme, the target asset allocation model, and the identified deficiency.

2. The financial advisory system of claim 1, wherein the existing asset allocation scheme comprises the percentage of the plurality of assets in at least one of an asset class, an industry segment, and a sector.

3. The financial advisory system of claim 1, wherein the plurality of assets comprises at least one of cash and real estate.

4. The financial advisory system of claim 1, wherein the plurality of assets comprises a security.

5. The financial advisory system of claim 4, wherein the information about the plurality of assets further comprises a number of shares of the security, a purchase date, and a price per share.

6. The financial advisory system of claim 1, wherein the historical information comprises at least one of a performance of the security over time, a capital event, and a shares held adjustment ratio.

7. The financial advisory system of claim 1, wherein the target asset allocation model comprises an allocation of assets in at least one of an asset class, an industry segment, and a sector.

8. The financial advisory system of claim 4, further comprising a tax optimization system configured to identify a tax lot of the security to sell to achieve the target asset allocation model.

9. The financial advisory system of claim 1, the display further comprising a report, wherein the report comprises at least one of a tax form populated with information about the asset to be sold to achieve the target asset allocation model, a gain and loss term based summary, a compound annual growth rate summary, a tax expense summary, and a dividend summary.

10. The financial advisory system of claim 1, the display further comprising an alert, wherein the alert comprises a notification to the user of an event related to the asset in the existing asset allocation scheme.

11. The financial advisory system of claim 10, wherein the notification comprising information about at least one of a capital event and a change in value.

12. The financial advisory system of claim 1, wherein the plurality of assets comprises an investment portfolio owned by the asset owner.

13. A computer-implemented method for balancing an allocation of a plurality of assets for an asset owner, comprising:
receiving identifying information about the plurality of assets and a financial risk tolerance profile of the asset owner;
storing the identifying information and the financial risk tolerance profile;
retrieving asset data from a repository database, the asset data comprising historical information about the plurality of assets;
retrieving information about market trends from an authoritative database;
generating an existing asset allocation scheme based on the plurality of assets;
generating a target asset allocation model, wherein the target asset allocation model comprises a recommended allocation of assets based on the asset owner's risk tolerance and market trends;
comparing the existing asset allocation scheme to the target asset allocation model to identify a deficiency, wherein the deficiency comprises one or more assets to be at least one of acquired and disposed of to modify the existing asset allocation scheme to achieve the target asset allocation model; and
displaying at least one of the existing asset allocation scheme, the target asset allocation model, and the identified deficiency.

14. A computer-implemented method for balancing an allocation of a plurality of assets for an asset owner according to claim 12, wherein the existing asset allocation scheme comprises the percentage of the plurality of assets in at least one of an asset class, an industry segment, and a sector.

15. A computer-implemented method for balancing an allocation of a plurality of assets for an asset owner according to claim 12, wherein the plurality of assets comprises at least one of cash and real estate.

16. A computer-implemented method for balancing an allocation of a plurality of assets for an asset owner according to claim 12, wherein the plurality of assets comprises a security.

17. A computer-implemented method for balancing an allocation of a plurality of assets for an asset owner according to claim 15, wherein the information about the plurality of assets further comprises a number of shares of the security, a purchase date, and a price per share.

18. A computer-implemented method for balancing an allocation of a plurality of assets for an asset owner according to claim 15, wherein the historical information comprises at least one of a performance of the security over time, a capital event, and a shares held adjustment ratio.

19. A computer-implemented method for balancing an allocation of a plurality of assets for an asset owner according to claim 12, wherein the target asset allocation model comprises an allocation of assets in at least one of an asset class, an industry segment, and a sector.

20. A computer-implemented method for balancing an allocation of a plurality of assets for an asset owner according to claim 15, further comprising a tax optimization system configured to identify a tax lot of the security to sell to achieve the target asset allocation model.

21. A computer-implemented method for balancing an allocation of a plurality of assets for an asset owner according to claim 12, the display further comprising a report, wherein the report comprises at least one of a tax form populated with information about the asset to be sold to achieve the target asset allocation model, a gain and loss term based summary, a compound annual growth rate summary, a tax expense summary, and a dividend summary.

22. A computer-implemented method for balancing an allocation of a plurality of assets for an asset owner according to claim 12, the display further comprising an alert, wherein the alert comprises a notification to the user of an event related to the asset in the existing asset allocation scheme.

23. A computer-implemented method for balancing an allocation of a plurality of assets for an asset owner according to claim 21, wherein the notification comprising information about at least one of a capital event and a change in value.

24. A computer-implemented method for balancing an allocation of a plurality of assets for an asset owner according to claim 12, wherein the plurality of assets comprises an investment portfolio owned by the asset owner.
